(19) United States
(12) Patent Application Publication
(10) Pub. No.: US 2003/0026167 A1
(43) Pub. Date: Feb. 6, 2003

(54) System and methods for detecting pressure signals generated by a downhole actuator

(75) Inventors: Detlef Hahn, Hannover (DE); Volker Peters, Wienhausen (DE); Cedric Rouatbi, Celle (DE)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX (US)

(21) Appl. No.: 10/200,988

(22) Filed: Jul. 23, 2002

Related U.S. Application Data
(60) Provisional application No. 60/307,743, filed on Jul. 25, 2001.

(51) Int. Cl. G01V 1/00

(52) U.S. Cl. 367/38; 367/76

(57) ABSTRACT

A system is presented for detecting downhole generated telemetry pressure pulses in a well. The system employs high sensitivity dynamic pressure sensors such as hydrophones for detecting the pulses in either the surface drilling fluid supply line or in the fluid return annulus. The high sensitivity allows detection of smaller surface pulses than standard transducers. In one embodiment, an annular pulser is used to generate pulses directly in the annulus.

### RELATED APPLICATION

This application is related to a U.S. provisional application titled “A System and Methods for Detecting Pressure Signals Generated by a Downhole Actuator” filed on Jul. 25, 2001, Ser. No. 60/307,743, and from which priority is claimed for the present application.

### BACKGROUND OF THE INVENTION

1. Field of the Invention

The present invention relates to drilling fluid telemetry systems and, more particularly, to methods for detecting high data rate pressure signals generated by a downhole actuator.

2. Description of the Related Art

Drilling fluid telemetry systems, generally referred to as mud pulse telemetry systems, are particularly adapted for telemetry of information from the bottom of a borehole to the surface of the earth during oil well drilling operations. The information telemetered often includes, but is not limited to, parameters of pressure, temperature, direction and deviation of the well bore. Other parameters include logging data such as resistivity of the various layers, sonic density, porosity, induction, self potential and pressure gradients. This information is critical to efficiency in the drilling operation.

Mud pulse telemetry consists of the transmission of information via a flowing column of drilling fluid, i.e., mud. The sensed downhole parameters are encoded into pressure pulses in the drilling fluid within the drill pipe or standpipe which are sensed at the surface. Pressure pulses are defined herein to describe both discrete pulses and continuous waves. These pressure pulses are produced by periodically modulating the flowing mud column at a point downhole by mechanical means, and the resulting periodic pressure pulses appearing at the surface end of the mud column are typically detected by a pressure transducer conveniently located in the standpipe. The drilling mud is pumped downwardly through the drill pipe (string) and then back to the surface through the annulus between the drill string and the wall of the well for the purpose of cooling the bit, removing cuttings produced by the operation of the drill bit from the vicinity of the bit and containing the downhole formation geopressure.

The pressure pulse signal is commonly detected at or near the standpipe using standpipe pressure transducers. This technique has been adequate and successful for relatively benign conditions with low noise levels and low information rates such as directional survey information (i.e., azimuth, inclination, etc.), but is not as successful when higher data rates, such as directional steering and formation data (resistivity, gamma, porosity, etc.), are being transmitted while the drill string is engaged in active, and often aggressive, drilling. During some transmissions, particularly under certain severe drilling conditions that can include, but is not limited to, deep wells and highly viscous mud systems, drilling artifacts get in the way of good signal decoding in the standpipe. In fact under certain drilling conditions, the pressure pulse signals in the standpipe cannot be decoded at all and downhole drilling information in real time cannot be supplied to the driller. Such drilling applications are expected to increase and new techniques are required to improve signal detection methods at the surface.

This inability to decode pressure signals in the standpipe is caused by the presence of interfering pressure pulses or noise, which can be larger than the received pulses. The primary cause of the pressure noise comes from the drilling fluid pumps. Other sources of noise include longitudinal drill string vibration, torsional vibration, bit vibration, accumulator resonance, hydraulic resonance in the drill string, and rig vibrations.

The highly undesirable result is that the driller is unable to use measurement-while-drilling techniques to obtain directional and formation information and must resort to more time consuming and expensive methods of obtaining necessary borehole information.

The oil drilling industry needs to effectively increase mud pulse data transmission rates to accommodate the ever increasing amount of measured downhole data. The major disadvantage of available mud pulse systems is the low data transmission rate. However, increasing the pulse rate or carrier frequency of the downhole generated pulse also results in increased attenuation of the pulse with the net result being a smaller pulse to detect at the surface.

The typical standpipe pressure sensor, used to detect the telemetered pulses, measures the total pressure at the standpipe. This includes both the pump base pressure needed for drilling purposes and the relatively small surface received pressure pulses superimposed on the pump pressure. A pump pressure of 3000 psi with a superimposed pulse pressure, at the surface, of 1-50 psi is not uncommon in typical mud pulse systems. At pulse frequencies higher than the typical 2-10 hz, the increased attenuation will reduce the available surface signal significantly below the noise level and render the pulse signals undetectable for commonly used pressure sensors in the standpipe.

Methods for decoding the pulse signals using annular pressure signals have been presented in U.S. Pat. No. 5,272,680. This patent disclosed detecting the pressure signal in the return annulus after it traversed through the bit and back up the annulus to the surface. The annulus pressure signals were at least an order of magnitude smaller in the annulus than the corresponding signal in the standpipe. As the pulse frequency is increased for higher data rates, the received annulus signal will become undetectable using standard pressure transducers.

Thus there is a demonstrated need for a pressure pulse detecting system that can detect pressure pulses several orders of magnitude smaller than can be detected with standard transducers.

### SUMMARY OF THE INVENTION

The present invention contemplates a mud pulse detection system using highly sensitive, dynamic pressure sensors for surface detection of downhole generated pressure pulses. The detection system is capable of detecting much smaller pulses than is possible with standard pressure transducers.

In a preferred embodiment, a system for detecting a downhole transmitted pressure signal in at least one fluid conduit in hydraulic communication with a downhole pulser, comprises at least one dynamic pressure sensor in fluid communication with at least one conduit. The dynamic pressure sensor detects the transmitted pressure signal in the conduit and generates an output in response thereto. A processing device is adapted to receive the sensor output from the dynamic pressure sensor and to process the output, according to programmed instructions, to enhance the recovery of the transmitted pressure signal. The at least one conduit may be the supply line, the return annulus, or both.

The preferred dynamic pressure sensor is a hydrophone. A positive pulser or negative pulser may be used to generate the pulses.

In another preferred embodiment, an annulus pulser generates the pulses directly in the annulus.

In another aspect, a method of detecting pressure signals in at least one fluid conduit from a downhole pulser, comprises placing at least one dynamic pressure sensor in fluid communication with the at least one fluid conduit. Dynamic pressure signals are detected in the at least one fluid conduit. The detected dynamic pressure signals are processed to enhance the recovery of the pressure signals. The preferred pressure sensors are hydrophones. The at least one fluid conduit may be the supply line, the return annulus, or both.

Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals, wherein:

FIG. 1 is a schematic diagram showing a drilling rig 1 engaged in drilling operations according to one embodiment of the present invention;

FIG. 2 is schematic of a downhole pulser according to one embodiment of the present invention;

FIG. 3 is a chart showing example surface pulse amplitudes vs. frequency according to one embodiment of the present invention;

FIG. 4 is a schematic showing the difference between measuring an absolute and dynamic pressure signal; and

FIG. 5 is a schematic showing a downhole annular pulser according to one embodiment of the present invention.

### DESCRIPTION OF PREFERRED EMBODIMENTS

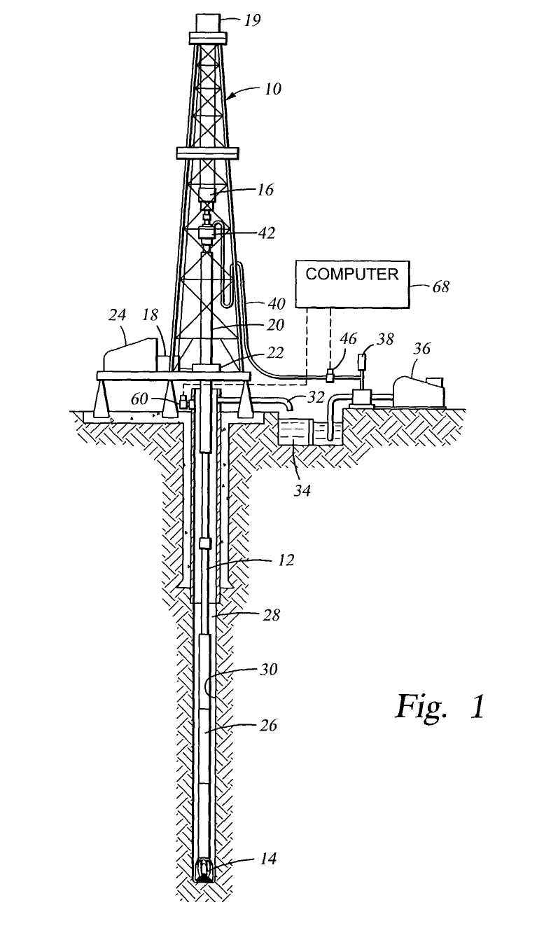

Referring to FIG. 1, a drilling apparatus is shown having a derrick 10 which supports a drill string, indicated generally at 12, which terminates in a drill bit 14. As is well known in the art, the entire drill string 12 may rotate, or the drill string 12 may be maintained stationary and only the drill bit 14 rotated. The drill string 12 is made up of a series of interconnected pipe segments, with new segments being added as the depth of the well increases. The drill string is suspended from a moveable block 16 of a winch 18 and a crown block 19, and the entire drill string 12 of the disclosed apparatus is driven in rotation by a square kelly 20 which slideably passes through and is rotatably driven by the rotary table 22 at the foot of the derrick 10. A motor assembly 24 is connected to both operate winch 18 and drive rotary table 22.

The lower part of the drill string 12 may contain one or more segments 26 of larger diameter than the other segments of the drill string 12. As is well known in the art, these larger diameter segments 26 may contain sensors and electronic circuitry for preprocessing signals provided by the sensors. Drill string segments 26 may also house power sources such as battery modules or mud driven turbines which drive generators, the generators in turn supplying electrical energy for operating the sensing elements and any data processing circuitry.

Drill cuttings produced by the operation of drill bit 14 are carried away by a drilling fluid, also called drilling mud, stream rising up through the free annular space 28 between the drill string and the wall 30 of the well. That mud is delivered via a pipe 32 to a filtering and decanting system, schematically shown as tank 34. The filtered mud is then drawn up by a pump 36, provided with a pulsation absorber 38, and is delivered via high pressure line 40, also called a standpipe, under pressure to revolving swivel head 42 and then to the interior of drill string 12 to be delivered to drill bit 14 and the mud turbine in drill string segment 26.

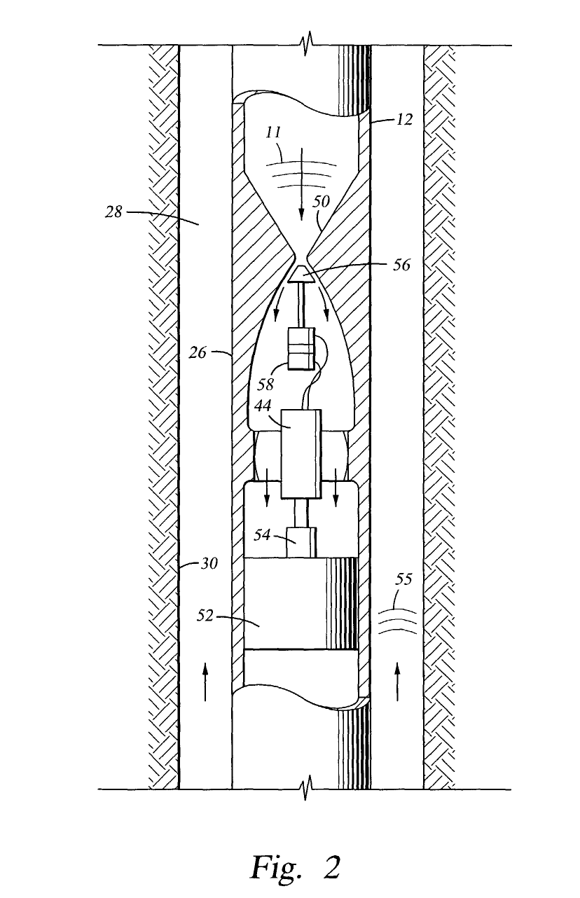

In a common MWD system as illustrated in FIG. 2, the mud column in drill string 12 serves as the transmission medium for carrying signals of downhole drilling parameters to the surface. This signal transmission is accomplished by the well known technique of mud pulse generation or mud pulse telemetry (MPT) whereby pressure pulses represented schematically 11 are generated in the mud column in drill string 12 representative of parameters sensed downhole.

The drilling parameters may be sensed in a sensor unit, or sensor module, 44 in drill string segment 26, as shown in FIG. 2 which is located near the drill bit. In accordance with well known techniques, the pressure pulses 11 established in the mud stream in drill string 12 are received at the surface by a pressure transducer 46 (FIG. 1) and the resulting electrical signals are subsequently transmitted to a signal receiving and processing device 68 (FIG. 1) which may record, display and/or perform computations, according to programmed instructions, on the signals to provide information of various conditions downhole.

Still referring to FIG. 2, the mud flowing down drill string 12 is caused to pass through a variable flow orifice 50, also called a pulser valve or pulser, and is then delivered to drive a turbine 52. The turbine 52 is mechanically coupled to, and thus drives the rotor of a generator 54 which provides electrical power for operating the sensors in the sensor unit 44. Alternatively, electric power may be supplied by downhole battery modules (not shown). The information bearing output of sensor unit 44, usually in the form of an electrical signal, operates a valve driver 58, which in turn operates a plunger 56 which varies the size of variable orifice 50. Plunger 56 may be electrically or hydraulically operated. The variations in the size of orifice 50 create the pressure pulses 11 in the drilling mud stream and these pressure pulses are sensed at the surface by aforementioned transducer 46 to provide indications of various conditions which are monitored by the condition sensors in unit 44. The direction of drilling mud flow is indicated by arrows on FIG. 2. The pressure pulses 11 travel up the downwardly flowing column of drilling mud and within drill string 12.

Sensor unit 44 will typically include circuits for converting the signals commensurate with the various parameters which are being monitored into a preselected coding and modulation scheme, and the thus encoded information is employed to control plunger 56. The sensor 46 at the surface will detect pressure pulses in the drilling mud stream and these pressure pulses will be commensurate with the code. In actual practice the coded signal will be manifested by a series of information bearing mud pulses which may include discrete pulses, or wave modulated pulses such as frequency keyed, phase keyed, or combinations of these types. The transmission of information to the surface via the modulated drilling mud stream will typically consist of signals commensurate with each of the borehole parameters being measured from sensors located in the bottomhole assembly. To effectively increase data rate for the transmission of information, frequencies greater than 10 hz will be required.

As noted above, the drilling mud, after passing downwardly through segment 26 of the drill string, washes the drill bit 14 and then returns to the surface via the return annulus 28 between the drill string and the wall 30 of the well, essentially creating a mud column inside the drill string 12 and a mud column in the return annulus 28. It is known that the pressure pulses resulting from the movements imparted to plunger 56, also travel down the drill string, through the bit 14 (see FIG. 1), and are propagated up the annulus 28 from the bottom of the well (although in greatly attenuated form), and result in pulses indicated schematically at 55 in FIG. 2 in annulus 28 that may be sensed at the surface. In order to measure this second annulus pressure pulse, a second pressure transducer 60, see FIG. 1, is located at the surface in the direction of returning mud flow. Typically, the magnitude of the pressure pulses detected by transducer 60 are at least an order of magnitude less than the corresponding or companion pressure pulses detected by transducer 46. However, the background noise in the annulus 28 is substantially lower than the background noise in the standpipe 40 making the annulus pulses detectable by transducer 60 for pulse rate in the 2-10 hz range. As the pulse frequency increases the attenuation also increases and will reduce the surface pulse amplitude to undetectable levels for standard pressure transducers at both the standpipe 40 and the annulus 28.

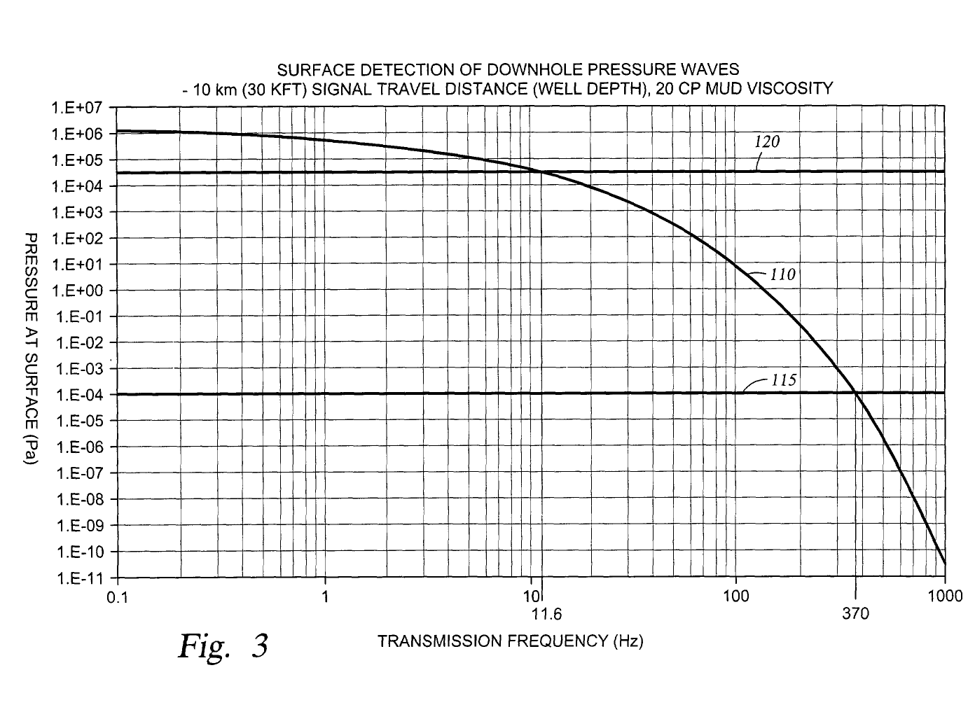

FIG. 3 shows a chart of predicted surface received pressure signals as a function of pulse frequency for a 30,000 ft well with 20 cp drilling fluid viscosity. The graph shows the surface pulse amplitude for downhole generated pulse amplitudes of 300 psi 110 on a logarithmic scale. Also shown are threshold detection levels for a standard pressure transducer 120 and for a hydrophone 115. The threshold detection levels 120 and 115 are based on 10 times the sensor sensitivity of a common hydrophone 115 and 10 times the repeatability of a commonly used pressure sensor 120 (rated for 5000 psi/350 bar), as will be discussed later. As is known in the art, the maximum total pressure drop across the pulser valve 50 is dictated by the need to avoid erosion, wear and excessive power consumption of the pulser valve 50. The total pressure drop is caused by nonpulsing baseline flow pressure losses and pulse signal pressure. Downhole generated signal pressure levels of 300 psi are at the high end of acceptable pulse levels and these levels typically cause excessive valve erosion and early failure of the downhole pulser. Smaller pressure drops are always preferable in regards to pulser reliability and power consumption, but the high signal pressures are often required because of poor surface detection capabilities.

As can be seen in FIG. 3, the surface pulse amplitude 110 from such a high downhole signal (300 psi) will be below the threshold detection level for standard transducers 120 at pulse frequencies above approximately 11 hz, and will be, therefore undetectable by a standard pressure transducer. The hydrophone threshold 115, however, shows that a typical hydrophone is capable of detecting the same amplitude pulse at frequencies up to about 370 hz.

As is known, a hydrophone is a highly sensitive measuring device for measuring time-varying, also called dynamic, pressure signals while at the same time being substantially insensitive to the changes in static pressure that take up most of the measuring range of the standard pressure transducer. Instead, the hydrophone essentially measures only the dynamic signal (i.e. the pulses) superimposed on the static pressure. For decoding the pressure pulse signals, only the dynamic pressure signal need be detected. The total pressure, static and dynamic, is only of interest to determine the burst limitations of the sensor. Hydrophones are available with resolutions on the order of 1×10⁻⁵ pascals (1.5×10⁻⁹ psi). Hydrophones are known in the art, and are commercially available to survive the pressure environments encountered in the standpipe or annulus and will not be described in further detail.

Pressure sensors are specified in regards to the absolute pressure by using the accuracy, the repeatability, and the resolution. Because of the hysteresis behavior of pressure sensors (different measurements on a increasing and decreasing pressure slope), the resolution cannot be considered as the parameter for the minimum detectable unit of interest, if dynamic change in pressure level must be measured. Here the repeatability should be considered as the smallest unit of interest For a good signal detection and evaluation, nominal industry practice assumes that sensors should have at least a 10 times better resolution than the minimum expected signal level. For a fair comparison to measure a dynamically changing pressure (signal), the signal level should be at least 10 times the sensitivity of a hydrophone 115, or 10 times the repeatability of a pressure sensor 120. As seen in FIG. 3, these hydrophone sensitivities allow substantially higher pulse frequencies to be transmitted while still providing a detectable surface signal or, alternatively, they allow lower amplitude pulses to be detected with present telemetry systems.

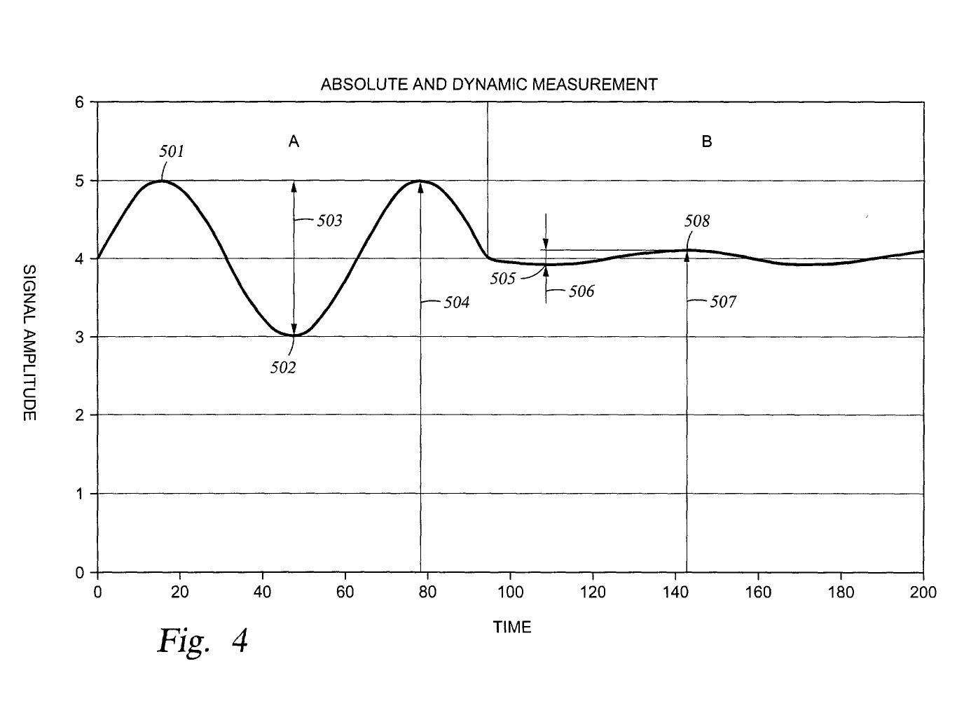

FIG. 4 shows an exemplary pressure signal 501 at a predetermined frequency and amplitude. The signal amplitude changes with time. In section A, the amplitude fluctuation 503 is ±1 unit and in section B of the chart the amplitude change 506 is ±0.1 unit. The units may be any suitable pressure measurement units and are left generic here for simplicity.

In the left section of FIG. 4, the absolute pressure sensors see a pressure signal from 5 at point 501 to 3 at point 502. The hydrophone sees a pressure change between −1 and +1. Therefore, the absolute pressure sensor must at least be scaled to 5, the hydrophone only to 2 (±1). If the amplitude does not change with time (equaling no change in signal), the absolute pressure sensor would still see an absolute pressure of 4. The hydrophone would not deliver a signal. Assume both sensors are able to detect a tenth of their scale. The pressure sensor detects a maximum of 5/10=0.5 units, while the hydrophone still recognizes a change of 2/10=0.2 units in amplitude. In this case both sensors are able to detect the signal (2 units) with sufficient resolution.

In section B, the pressure signal is much smaller. It changes ±0.1 units in amplitude 506. An absolute pressure sensor must at least be scaled to a maximum pressure of 4.1 units 508. The hydrophone must at least be scaled to a pressure change of ±0.1≡0.2 units 506. Assuming again both sensors are able to detect a tenth of their scale, the pressure sensor (4.1/10=0.41 units) would not be able to detect the signal (maximum 0.2 units). The hydrophone (0.2/10=0.02 units) would still be able to easily detect the signal. As this example shows, absolute pressure sensors are able to detect time varying signals in acceptable manner, if the signal amplitude (the alternating content of the amplitude) is large in regards to the absolute amplitude. Hydrophones are much better suited to detect the change in pressure amplitude.

The higher hydrophone sensitivity may be used for detecting pulses in the standpipe or annulus of the presently available systems. Using suitable filtering techniques known in the art, the hydrophone can detect smaller pulse signals than can be detected using standard transducers. In the lower background noise environment of the annulus 28, the hydrophone can be used to detect the smaller amplitude signals propagating up the annulus 28. Different hydrophones may be used in the standpipe and the annulus due to the different physical constraints required to mechanically fit in the different locations.

While positive pulsing systems have been described, it will be appreciated that the annulus detection will also be suitable for use with negative pulsing techniques. In a negative pulsing system, a portion of the higher pressure drilling fluid inside the drill string is vented to the annulus, thereby creating a negative pulse propagating to the surface inside the drill string and a positive pulse in the annulus. The annulus pulse can be detected by the hydrophone mounted in the annulus.

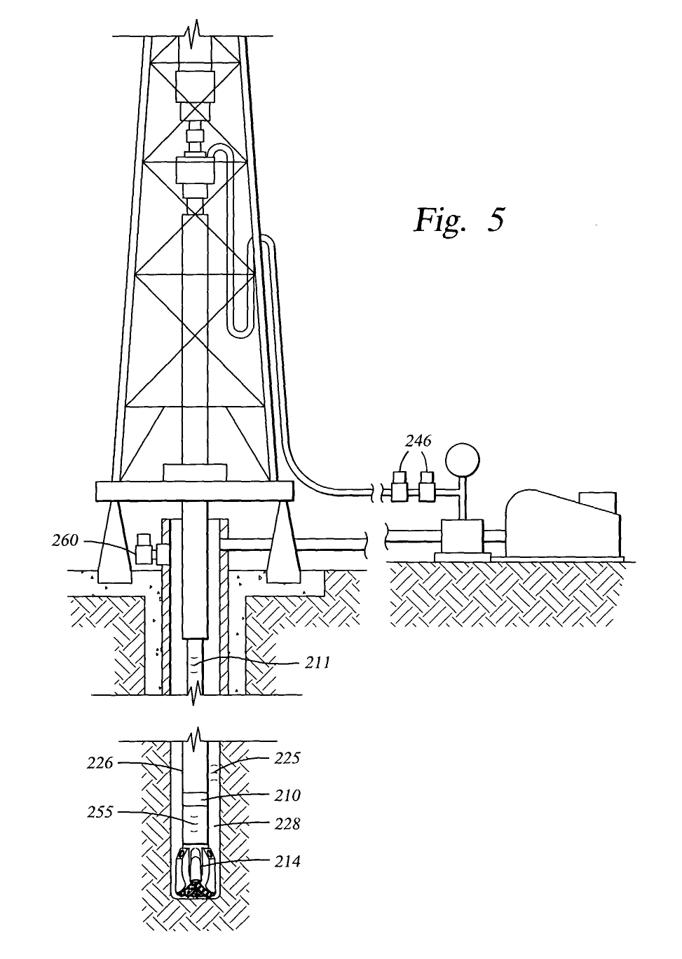

In another embodiment, seen in FIG. 5, an annular pulser 210 is mounted on the external portion of downhole segment 226 and generates pulses 225 directly in the annulus 228 which propagate up the annulus 228 and are detected by the annulus hydrophone 260. The pulses generated also propagate down to the drill bit 214 and up the bore of the drill segments in a highly attenuated manner, illustrated schematically as 211, and are detected by hydrophones 246. The annular pulser 210 may include piezoelectric elements or magneto-strictive elements to generate a pulse 225 in the drilling fluid.

With the need of faster transmission rates (faster signal changes and higher frequencies), in deeper wells (smaller received signal amplitudes with larger absolute pressures at surface), it will be essential to use hydrophones instead of absolute pressure sensors to detect small pressure signals from downhole.

The foregoing description is directed to particular embodiments of the present invention for the purpose of illustration and explanation. It will be apparent, however, to one skilled in the art that many modifications and changes to the embodiment set forth above are possible without departing from the scope of the invention. It is intended that the following claims be interpreted to embrace all such modifications and changes.

What is claimed is:

1. A system for detecting a downhole transmitted pressure signal in at least one fluid conduit in hydraulic communication with a downhole pulser, comprising:
at least one dynamic pressure sensor in fluid communication with said at least one conduit detecting said transmitted pressure signal and generating an output in response thereto; and
a processing device adapted to receive said sensor output from said at least one dynamic pressure sensor and to process said output, according to programmed instructions, to enhance the recovery of said transmitted pressure signal.

2. The system of claim 1, wherein the at least one dynamic pressure sensor is a hydrophone.

3. The system of claim 1, wherein said at least one conduit is at least one of (i) a supply line, (ii) a return annulus, and (iii) the supply line and the return annulus.

4. The system of claim 1, wherein the downhole pulser generates the pressure signal directly into the return annulus.

5. The system of claim 1, wherein the pressure signal is one of (i) a positive pulse, (ii) a negative pulse, (iii) a modulated continuous wave.

6. A method of detecting a downhole generated pressure signal in at least one fluid conduit from a downhole pulser, comprising;
placing at least one dynamic pressure sensor in fluid communication with said at least one fluid conduit;
detecting dynamic pressure signals in said at least one fluid conduit; and
processing said detected dynamic pressure signals to enhance the recovery of said signals.

7. The method of claim 6, wherein the at least one dynamic pressure sensor is a hydrophone.

8. The method of claim 6, wherein the at least one fluid conduit is at least one of (i) a supply line, (ii) a return annulus, and (iii) the supply line and the return annulus.

9. The method of claim 6, wherein the downhole pulser generates the pressure signal directly into the return annulus.

10. The method of claim 6, wherein the pressure signal is one of (i) a positive pulse, (ii) a negative pulse, (iii) a modulated continuous wave.

11. A system for detecting a downhole transmitted pressure signal in at least one fluid conduit in hydraulic communication with a downhole pulser, comprising:
at least one hydrophone in fluid communication with said at least one conduit detecting said transmitted pressure signal and generating an output in response thereto; and
a processing device adapted to receive said sensor output from said at least one dynamic pressure sensor and to process said output, according to programmed instructions, to enhance the recovery of said transmitted pressure signal.

12. The system of claim 11, wherein said at least one conduit is at least one of (i) a supply line, (ii) a return annulus, and (iii) the supply line and the return annulus.

13. The system of claim 11, wherein the downhole pulser generates the pressure signal directly into the return annulus.

14. The system of claim 11, wherein the pressure signal is one of (i) a positive pulse, (ii) a negative pulse, (iii) a modulated continuous wave.

15. A method of detecting pressure signals in at least one fluid conduit from a downhole pulser, comprising;
placing at least one hydrophone in fluid communication with said at least one fluid conduit;
detecting dynamic pressure signals in said at least one fluid conduit; and
processing said detected dynamic pressure signals to enhance the recovery of said signals.

16. The method of claim 15, wherein the at least one fluid conduit is at least one of (i) a supply line, (ii) a return annulus, and (iii) the supply line and the return annulus.

17. The method of claim 15, wherein the downhole pulser generates the pressure signal directly into the return annulus.

18. The method of claim 15, wherein the pressure signal is one of (i) a positive pulse, (ii) a negative pulse, (iii) a modulated continuous wave.
